(19) United States
(12) Patent Application Publication
(10) Pub. No.: US 2009/0228388 A1
(43) Pub. Date: Sep. 10, 2009

(54) SYSTEM AND METHOD FOR AUTOMATED TRADING OF ELECTRICAL CONSUMPTION

(75) Inventors: Zach Axelrod, Washington, DC (US); Brian Golden, Great Falls, VA (US); Louis Szablya, Houston, TX (US)

Correspondence Address: GREENBERG TRAURIG, LLP, 2101 L Street, N.W., Suite 1000, Washington, DC, 20037, US

(73) Assignee: GridPoint, Inc., Arlington, VA (US)

(21) Appl. No.: 12/400,511

(22) Filed: Mar. 9, 2009

Related U.S. Application Data
(60) Provisional application No. 61/034,841, filed on Mar. 7, 2008.

(51) Int. Cl. G06Q 40/00

(52) U.S. Cl. 705/37

(57) ABSTRACT

A system and method for automated trading of electrical consumption. A plurality of demand bids for energy on a power grid from a plurality of consumers are received, over a network. Each demand bid comprises an identification of a consumer, a quantity of energy, an economic value of the bid, and one or more demand bid criteria. Data relating to the price of energy on the power grid is received over the network. It is then determined, using at least one computing device, if not servicing at least one of the demand bids will decrease the locational marginal price of energy on the power grid. An offer for compensation is then transmitted, over the network, to the load associated with demand bids, wherein the consumer receives the compensation if the consumer does not consume the energy related to the at least one of the demand bids.

This application claims the benefit of U.S. Provisional Application No. 61/034,841, entitled “Method and System for Automated Trading of Electrical Consumption to Maximize Societal Benefits”, filed Mar. 7, 2008, the disclosure of which is herein incorporated by reference in its entirety.

This application relates to the subject matter of U.S. patent application Ser. No. 12/118,644, entitled “Method and System for Scheduling The Discharge Of Distributed Power Storage Devices And For Levelizing Dispatch Participation”, filed May 9, 2008, U.S. patent application Ser. No. 11/968,941 entitled “Utility Console for Controlling Energy Resources” filed Jan. 3, 2008, U.S. Patent Application Serial Number 12210761 entitled “User Interface For Demand Side Energy Management” filed Sep. 15, 2008, and U.S. patent application Ser. No. 12/175,327 filed Jul. 17, 2008 entitled Method and System for Measurement and Control of Individual Circuits,” each of which is incorporated herein by reference in its entirety.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD OF THE INVENTION

The present invention relates in general to the field of electric power distribution systems, and in particular to methods and systems for managing distribution through use of an aggregated demand stack to maintain price stability and maximize distribution efficiency, thereby maximizing net system benefits.

### BACKGROUND OF THE INVENTION

Deregulation of the bulk electric power market has led to the development of organized markets for electric power. Load Serving Entities (LSEs), for example, a local utility, bid for and sell electric power on a daily basis within a power grid administered by a Regional Transmission Organization (RTO) or an Independent System Operator (ISO), for example, CAISO in California.

Power within an RTO originates from multiple generation sources. Such power generators may be owned by an LSE within the RTO, or may be independently owned and operated by private concerns. Such generators may be in continuous operation, or they may be called upon only during periods of peak demand. The cost of generation varies from point to point, and typically when auxiliary generators are called into service the cost of generation increases.

An LSE will typically attempt to purchase power from the lowest cost source. The cost of electricity to a given LSE within an organized electricity market is the locational marginal price (LMP); this is the locational pricing system used by most RTOs and ISOs. Under LMP, the price at each location in the grid at any given time reflects the cost of making available an additional unit of energy for purchase at that location and time.

Until recently, demand for electricity has had a nearly perfectly inelastic nature in the short run, for practical reasons. Sending pricing signals was too expensive, and only for the largest consumers were the transaction costs low enough to warrant constant monitoring and action. The market realities therefore led to average pricing systems in order to eliminate the need for this constant monitoring and action.

However, as with any commodity, the elasticity of demand for electric power is not perfectly inelastic. At higher prices residential, commercial, and industrial consumers will consume less, either by substituting a different energy source or by simply conserving.

Improved measurement and verification technology would allow for a new level of cost-effective consumer participation in the real-time LMP market, so that consumers are not simply passive, but instead may have increased ability to determine their own valuations of using or not using energy at any point. Circuit-level value-based differentiation by the consumer can re-shape the demand curve from one that is nearly perfectly inelastic to one that has a kinked elastic tail for non-essential, lower value loads.

### SUMMARY OF THE INVENTION

In one embodiment, the invention is a method for automated trading of electrical consumption. A plurality of demand bids for energy on a power grid from a plurality of consumers are received, over a network. Each demand bid comprises an identification of a consumer, a quantity of energy, an economic value of the bid, and one or more demand bid criteria. Data relating to the price of energy on the power grid is received over the network. It is then determined, using at least one computing device, if not servicing at least one of the demand bids will decrease the locational marginal price of energy on the power grid. An offer for compensation is then transmitted, over the network, to the load associated with demand bids, wherein the consumer receives the compensation if the consumer does not consume the energy related to the at least one of the demand bids.

In another embodiment, the invention is a system for automated trading of electrical consumption. The system comprises a plurality of consumer systems operatively connected to a network, wherein each of the consumer systems is configured to accept a plurality of demand bids for energy on a power grid from a consumer. Each demand bid comprises an identification of a consumer, a quantity of energy, an economic value of the bid, and one or more demand bid criteria. Each of the consumer systems are further configured to transmit the plurality of demand bids over the network. The system further comprises at least one control server operatively connected to the network, wherein the at least one control server is configured to receive the plurality of demand bids, and wherein the control server is further configured to receive, over the network, data relating to the price of energy on the power grid. The control server is further configured to determine, if not servicing at least one of the plurality of demand bids will decrease the locational marginal price of energy on the power grid, and to transmit, over the network, an offer for compensation to the consumer from which the at least one of the demand bids originated, wherein the consumer receives the compensation if the consumer does not consume the energy related to the at least one of the demand bids.

### BRIEF DESCRIPTION OF THE DRAWINGS

The foregoing and other objects, features, and advantages of the invention will be apparent from the following more particular description of preferred embodiments as illustrated in the accompanying drawings, in which reference characters refer to the same parts throughout the various views. The drawings are not necessarily to scale, emphasis instead being placed upon illustrating principles of the invention.

FIG. 1, a simplified operational diagram illustrates how congestion charges arise.

FIG. 2 shows a hypothetical scenario within the current prevalent market system, in which consumers pay average retail pricing.

FIG. 3 illustrates one embodiment of an energy trading system for balancing energy supply and demand such that an efficient level of energy consumption is reached.

FIG. 4 illustrates a hypothetical real-time pricing scenario facilitated by real-time communications between the LSE and the consumer (e.g. demand bidding) and real-time measurement and verification provided by ADMs at consumer locations.

### DETAILED DESCRIPTION

The present invention is described below with reference to block diagrams and operational illustrations of methods and devices to select and present media related to a specific topic. It is understood that each block of the block diagrams or operational illustrations, and combinations of blocks in the block diagrams or operational illustrations, can be implemented by means of analog or digital hardware and computer program instructions.

These computer program instructions can be provided to a processor of a general purpose computer, special purpose computer, ASIC, or other programmable data processing apparatus, such that the instructions, which execute via the processor of the computer or other programmable data processing apparatus, implements the functions/acts specified in the block diagrams or operational block or blocks.

In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and applications software which support the services provided by the server.

For the purposes of this disclosure, a computer readable medium stores computer data in machine readable form. By way of example, and not limitation, a computer readable medium can comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid-state memory technology, CD-ROM, DVD, or other optical storage, magnetic cassettes, magnetic tape, magnetic disk storage or other mass storage devices, or any other medium which can be used to store the desired information and which can be accessed by the computer.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium. Modules may be integral to one or more servers, or be loaded and executed by one or more servers. One or more modules may grouped into an engine or an application.

The trading platform system described herein allows end-users of electricity to input a value for a commodity, differentiated by all circuits under their control and the utility's operator's control thereby creating a demand stack. LSEs have ready access to information about power supply, including units and marginal costs of generation; the aggregation of this information generates a supply stack. The aggregation of the supply stack and demand stack data into a database permits the visualization of these two stacks in conjunction with retail energy rates. This allows for the system operator to move up the supply and demand stacks until an efficient level of consumption is reached.

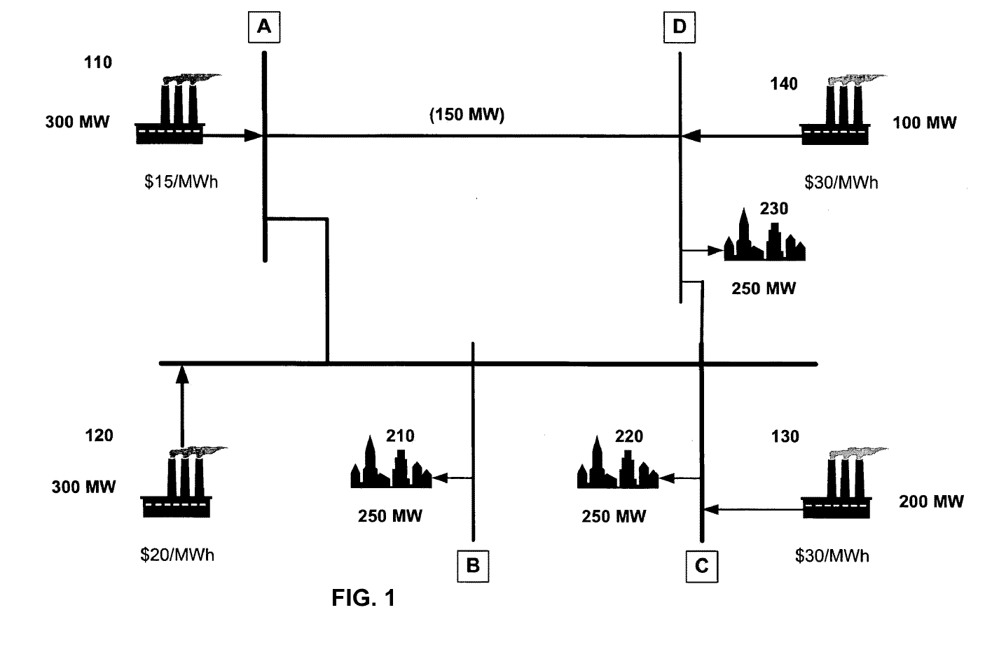

Inefficient energy consumption can lead to congestion charges which can, inter alia, raise the LMP of power consumed by load points. Referring to FIG. 1, a simplified operational diagram illustrates how congestion charges arise. Load points, 210, 220, and 230, which may be, for example, large commercial customers or local LSE's, have power demands which must be satisfied by obtaining power from generation points, 110, 120, 130, and 140. Ideally, all load points would prefer to obtain power from generation point 110, which has the lowest cost per MWh. If generation point 110 has sufficient capacity to supply all load points, and power transmission facilities are adequate to carry all demand, then every load point would obtain power from generation point 110 at $15/MWh.

However, assume the transmission facilities from point A to point D have a physical (e.g. thermal) limit of 150 MW. Load point 230 requires 250 MWs. After obtaining 150 MW of power from the path A-D, the path is at capacity, and may be said to be congested. Load point 230 will be forced to obtain 100 MW of power from generation point 130 or 140 at a cost of $30/MWh. Thus, the LMP at load point 230 is $30/MWh. The congestion charge for the path A-D is thus $30/MWh−$15/MWh. If the congestion charges can be avoided, on the other hand, the LMP remains at $15/MWh.

If the elasticity of demand is great or if the marginal cost of an additional unit of demand that can be taken off the system is great, such as is typically the case in congested locations, it may make sense to pay to shed certain consumption that would have occurred under otherwise market-clearing prices, to the benefit of all remaining consumers under the LMP system. In this way economic benefit can be maximized and distributed to the advantage of all participants.

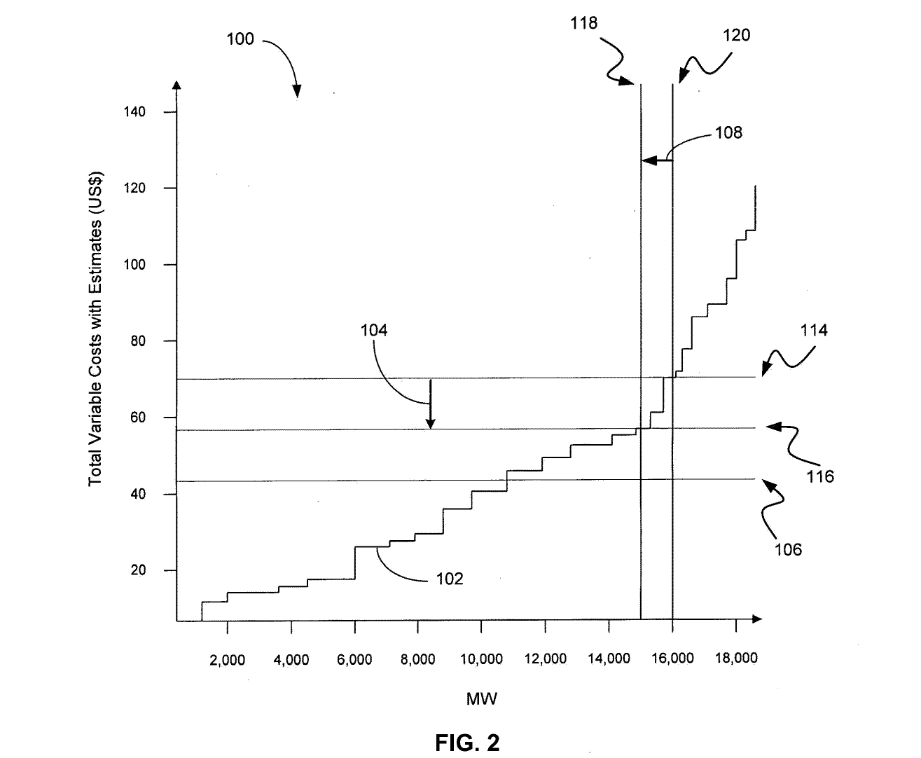

FIG. 2 shows a hypothetical scenario within the current prevalent market system 100, in which consumers pay average retail pricing 106. The average price is distorted upwards because average pricing encourages consumers to use too much energy when the cost of energy is high, and not enough energy when the cost of energy is low since all consumers pay the average retail price for energy regardless of when it is consumed. In a peak or semi-peak period, when the wholesale cost of energy exceeds the retail rate, the utility is actually losing money on every MWh it serves.

During periods in which wholesale LMPs are greater than the average retail price paid by consumers, it may be to the benefit of both LSEs and consumers for the LSE to pay consumers to reduce consumption. For example, in FIG. 2, the supply stack 102 intersects with demand curves 118 and 120. A curtailment of roughly 1,000 MW of load 108 would lead to a reduction in the price of energy paid by the LSE of $15/MWh 104 to serve the remaining consumers. Value 104 is realized by the utility for all consumers representing the remaining 15,000 MW of load.

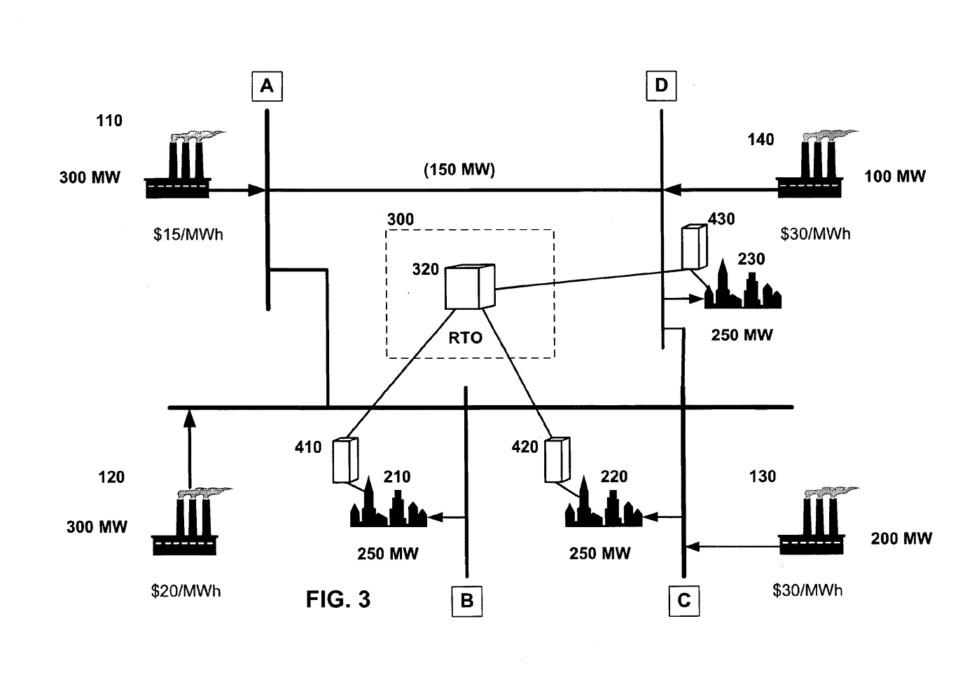

FIG. 3 illustrates one embodiment of an energy trading system for balancing energy supply and demand such that an efficient level of energy consumption is reached.

The system is implemented such that there that there are consumers 210, 220 and 230 at every pricing location within a power grid controlled by the system. Consumer systems Advanced Demand Management (ADM) systems 410, 420, and 430, are installed at each consumer location. In one embodiment, the ADM systems 410, 420, and 430 can comprise general purpose computer systems or embedded computing devices running application-specific software. In one embodiment, the ADM systems are programmable systems capable of automatically scheduling and managing the use of specific transmission paths at a load point using user defined value parameters. In one embodiment, the ADMs 410, 420, and 430 provide capabilities that allow for measurement, control, and predictive capabilities (through learning algorithms) of circuit-level loads.

In one embodiment, the ADM systems 410, 420, and 430 provide a user interface that allow consumers to enter demand bids that each comprise an identification of a consumer, a quantity of energy, an economic value of the bid, and one or more demand bid criteria such as, for example, a time, a time range, differentiation from a given setpoint, or any other metric. In one embodiment, the user interface is provided on a display device directly connected to the ADM. In one embodiment, the user interface is provided via a network on a display device remote from the ADM. In one embodiment, the user interface is provided via a network, such as the Internet, on a website. In one embodiment, demand bids are differentiated by all circuits under the control of the ADM and the RTO or other LSE 300.

In one embodiment, the ADM systems 410, 420, and 430 are operatively connected to a control server 320 at the RTO 300 via a public network, such as the Internet or a public wireless network, or via a private network such as a WAN or private wireless network. The control server 320 comprise a cluster of one or more general purpose computer systems or embedded computing devices running application-specific software. The control server could also be implemented on a server owned and controlled by a third party, who is neither an LSE nor a consumer, who provides control services to RTOs, LSEs and or consumers.

In one embodiment, the control server 320 collects and stores information about available power supplies, including units and marginal costs of generation. The control server can use this information to generate a supply stack such as, for example, the supply stack 102 of FIG. 1. In one embodiment, the control server 320 collects and stores demand bids from all attached ADM systems 410, 420, and 430 and aggregates the demand bids into a demand stack. In one embodiment, the supply stack and demand stack data are aggregated into a database permits the visualization of these two stacks in conjunction with retail energy rates allows for a determination of consumer surplus and utility surplus (as well as producer surplus.)

An LSE (such as the RTO) can use the visualized supply and demand stacks to manage consumption to enhance cost effectiveness of power consumption. For example, in order to determine which consumption should be shed, the LSE can pull from the demand stack those loads which are registered with the lowest value. In one embodiment, the LSE can actually pay the consumer for not servicing the load such that the net benefit to the consumer of not consuming is greater than the net benefit would have been from consuming, thereby increasing the consumer's utility in response to his decreasing his use of energy. The LSE's utility is increased due to the net value of not having to purchase the wholesale energy minus the lost revenues from the consumer minus the payment to that now non-consumer. All non-participant consumers benefit due to decreased revenue requirements for the RTO. They may also benefit from decreases in LMPs resulting from decreased quantity demanded.

The trading platform system can be used to seek to maximize the sum of consumer and utility surplus in times where wholesale LMPs are above retail rates by using algorithms to determine which loads should be pulled off the system, determining how much value this will create, and then using agreements between consumers and utilities to redistribute benefits. In one embodiment, the system may function with data from only one end-user, if an average-pricing model is employed for energy pricing. However, greater utility can be provided if values and loads are provided by multiple end-users.

Other value for the LSE is present as well even if the LMP does not drop. For example, referring to FIG. 1, Price 106 represents the price paid by consumers in an average pricing scenario. Assuming for simplicity that the entire system is served by one utility (the analysis does not change when it is not, but the value to the internal system does), the utility, pre-load curtailment, is paying $73/MWh (114) for energy for which it can charge only $42/MWh (106) (which includes its fixed costs). It is therefore in the utility's best interest to curtail load in order to reduce its losses.

For example, assume a customer places value of energy for his HVAC of $50/MWh. Were he to pay the cost to create and distribute this energy, he would pay more than $73/MWh 114. However, because of average pricing, he pays $42/MWh 106, and therefore receives a net benefit of $8/MWh from consumption. On the other hand, if the customer were to enter demand bid into the system for $50/MWh, upon visualizing demand and supply stacks, the RTO would be able to see that raising that customer's thermostat setting and reducing his demand would be beneficial to both parties, if, for example, the utility offered the consumer a rebate of $15/MWh to not use the energy at all.

The customer, who was previously $8/MWh better off by using the energy, now is $15/MWh better off by not using it, so he gains. The utility was losing $31/MWh by servicing this customer, but now loses only $15/MWh by not serving him, the cost of paying the customer not to consume. (This net benefit of $16/MWh for the utility and $7/MWh for the customer are realized at the expense of the generator, who sells less electricity, and potentially sells it at a lower rate.)

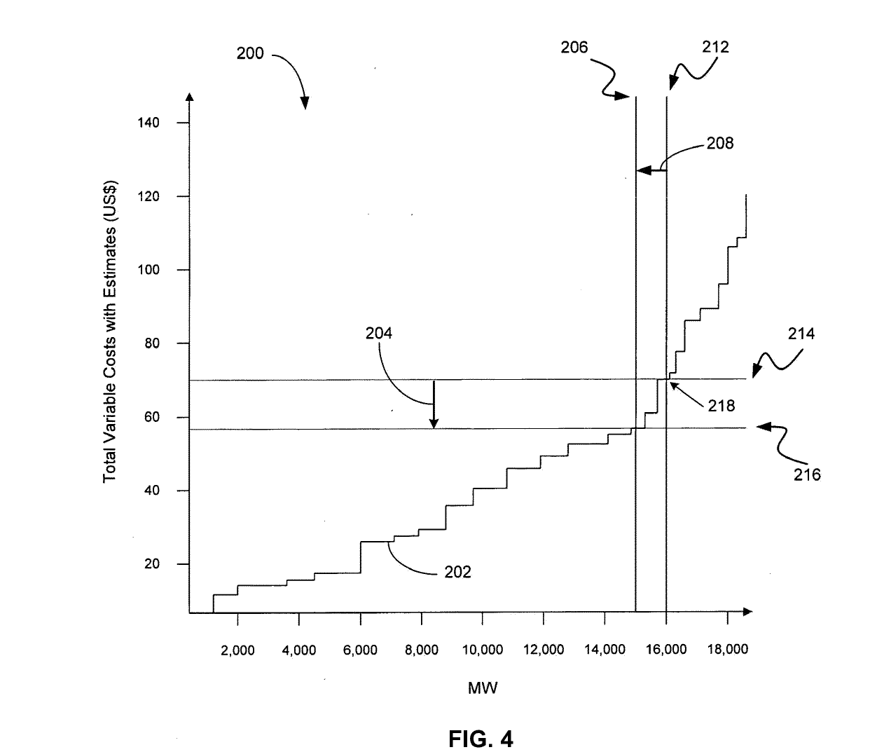

The above examples assumed average pricing scenarios. The present system and method can also be adapted to real-time pricing. FIG. 4 illustrates a hypothetical real-time pricing scenario facilitated by real-time communications between the LSE and the consumer (e.g. demand bidding) and real-time measurement and verification provided by ADMs at consumer locations. In a real-time pricing scenarios, wholesale energy costs are passed through to the consumer but the benefit amongst consumers of having a correctly built demand stack remains, as at market clearing prices those consumers with the lowest net value of consumption could effectively sell their non-consumption to all other consumers. In any situation where the elasticity of demand is great and especially when congestion occurs, it is likely that trading would take place to maximize value for all participants, both consumers and active non-consumers, who benefit from decreasing LMPs.

In FIG. 4, if consumer demand is not managed, the LMP at 16,000 MW of load has an LMP of $73/MWh 218. With a trading system as described herein, however, the LSE might, for example, see that roughly 1000 MW at a price of $73/MWh would be consumed by people who place a value on that energy of $80/MWh (not shown), and who are thus $7/MWh better off by consuming. However, removing their consumption 208 reduces the price of energy from $73/MWh to $58/MWh 204 for the remaining 15,000 MW worth of load 206, a savings of $225,000 (i.e., $15/MWh×15,000 MW for one hour) split among consumers.

In such a case, the trading system can provide an incentive to the low value consumers to encourage them to reduce their use of power. For example, if the utility were to pay the consumers with a low net value of consumption ($7/MWh) to not use power, plus an additional $20/MWh for their trouble (which value may be determined, for example, algorithmically by the system), these consumers would be markedly better off by not consuming. All other consumers benefit as well, because now their cost of consumption has fallen without any active participation on their part.

In addition to these benefits, if enough customers are selected by the utility to participate in this process at any given time, and an energy generating unit (such as a power plant) which would otherwise have been required to be online is no longer needed, the marginal price of energy for all customers drops, providing value for all consumers, as described above. This phenomenon is especially the case in congested locations, in which the marginal price is set by local power plants. If use of these local units can be reduced due to load reductions behind the congestion, the congestion will decrease and the LMP for that location will drop.

Note that, in some energy markets, a consumer can offset the effect of congestion charges using Financial Transmission Rights (FTRs), which are rights to collect congestion charges on a given path. For example, referring back to FIG. 1, a load point 230 may elect to obtain FTRs on path A-D to offset congestion charges (e.g. if the load point incurs congestion charges on path A-D, the load point is entitled to reimbursement of such congestion charges.) Consumer 230 may also obtain FTRs for the path B C, and collect any congestion charges accruing on that network segment as well. Furthermore, consumer 230 may elect to obtain all of its power from a supply off of the grid in FIG. 1, if such a supply was for a lower net cost than power obtained from the grid. In such a case, load point 230 could still collect congestion charges from path A-D, if that path remained congested.

In one embodiment, the trading platform above could be adapted to gather and store data relating to power consumption, FTRs, and other transmission rights. In one embodiment, the trading platform can be configured to automatically bid on behalf of a load for FTRs. For example, if a load enters a demand bid into the trading platform for 150 MWh at $50/MWh, the trading platform could enter a bid on behalf of the load for FTRs at the desired price. In one embodiment, real-time automated bidding incorporates the functions of automated bidding, but can additionally implement real-time algorithms to capture real time price excursions if power is scheduled on a real-time or near-time basis (many RTO's schedule transmission hourly, so this feature may require enhancements in RTO power scheduling).

Such bidding could be performed at the RTO/LSE level, or could be executed by ADMs at a consumer location. In one embodiment of dynamic automated bidding, the system incorporates the functions of automated bidding, but additionally may respond to a dynamic signal from the RTO to keep congestion at or below a certain point, or to respond to rapid market price fluctuations.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

We claim:

1. A method for automated trading of electrical consumption comprising the steps of:
receiving, over a network, a plurality of demand bids for energy on a power grid from a plurality of consumers, wherein each demand bid comprises an identification of a consumer, a quantity of energy, an economic value of the bid, and one or more demand bid criteria;
receiving, over the network, data relating to the price of energy on the power grid;
determining, using at least one computing device, if not servicing at least one of the plurality of demand bids will decrease the locational marginal price of energy on the power grid;
transmitting, over the network, an offer for compensation to the load associated with the at least one of the plurality demand bids, wherein the consumer receives the compensation if the consumer does not consume the energy related to the at least one of the demand bids.

2. The method of claim 1 wherein the demand bid criteria comprise at least one criteria selected from the set of criteria consisting of: a time, a time range, differentiation from a given setpoint.

3. The method of claim 1 comprising the additional steps of:
aggregating, using at least one computing device, the demand bids into a demand stack; and
aggregating, using the at least one computing device, the data relating to the price of energy on the power grid into a supply stack, wherein the determining step uses the demand stack and the supply stack to determine if not servicing at least one of the demand bids will decrease the locational marginal price of energy on the power grid.

4. The system of claim 1 wherein at least some of the demand bids additionally comprise an identification of a circuit under the control of the consumer from which the bid originated.

5. A method for automated trading of electrical consumption comprising the steps of:
receiving, over a network, a plurality of demand bids for energy on a power grid from a plurality of consumers, wherein each demand bid comprises an identification of a consumer, a quantity of energy, an economic value of the bid, and one or more demand bid criteria;
receiving, over the network, data relating to the price of energy on the power grid;
determining, using at least one computing device, if not servicing at least one of the plurality of demand bids will decrease the locational marginal price of energy on the power grid;
determining, using the at least one computing device, if the consumer associated with the at least one of the demand bids has an agreement with an LSE to defer consumption of energy related to a demand bid for a predetermined compensation if the consumer is commanded to defer consumption of energy related to a demand bid;
commanding, over the network, a consumer to defer consumption of energy related to a demand bid.

6. A system for automated trading of electrical consumption comprising:
a plurality of consumer systems operatively connected to a network, wherein each of the consumer systems is configured to accept a plurality of demand bids for energy on a power grid from a consumer, wherein each demand bid comprises an identification of a consumer, a quantity of energy, an economic value of the bid, and one or more demand bid criteria, and wherein each of the consumer systems are further configured to transmit the plurality of demand bids over the network;
at least one control server operatively connected to the network, wherein the at least one control server is configured to receive the plurality of demand bids, and wherein the control server is further configured to receive, over the network, data relating to the price of energy on the power grid, and wherein the at least one control server is further configured to determine if not servicing at least one of the plurality of demand bids will decrease the locational marginal price of energy on the power grid, and wherein the control server is further configured to transmit over the network, an offer for compensation to the consumer from which the at least one of the demand bids originated, wherein the consumer receives the compensation if the consumer does not consume the energy related to the at least one of the demand bids.

7. The system of claim 6 wherein the demand bid criteria comprise at least one criteria selected from the list: a time, a time range, differentiation from a given setpoint.

8. The system of claim 6 wherein the at least one control server is configured to aggregate the plurality of demand bids into a demand stack and to aggregate the data relating to the price of energy on the power grid into a supply stack, wherein the at least one control server is further configured to use the demand stack and the supply stack to determine if not servicing at least one of the demand bids will decrease the locational marginal price of energy on the power grid.

9. The system of claim 8 wherein the demand stack and supply stack are saved on a computer readable medium and wherein the at least one control server is further configured to display a representation of a demand stack and supply stack on a user interface tangibly displayed on a display device operatively connected to the at least one control server.

10. The system of claim 6 wherein at least some of the demand bids additionally comprise an identification of a circuit under the control of the consumer from which the bid originated.

11. The system of claim 6 wherein the at least one control server is further configured to determine if the consumer associated with the at least one of the demand bids has an agreement with an LSE to defer consumption of energy related to a demand bid for a predetermined compensation if the consumer is commanded to defer consumption of energy related to a demand bid and wherein the at least one control server is further configured to command the consumer from which the at least one of the demand bids originated to defer consumption of energy related to a demand bid.

12. The system of claim 6 wherein at least some of the plurality of consumer systems are advanced demand management systems.

13. The system of claim 6 wherein the at least one control server is operated by an LSE.

14. The system of claim 6 wherein the at least one control server is operated by an third party who is not a consumer or an LSE.

15. A computer-readable medium having computer-executable instructions for a method for automated trading of electrical consumption comprising the steps of:
receiving, over a network, a plurality of demand bids for energy on a power grid from a plurality of consumers, wherein each demand bid comprises an identification of a consumer, a quantity of energy, an economic value of the bid, and one or more demand bid criteria;
receiving, over the network, data relating to the price of energy on the power grid;
determining, using at least one computing device, if not servicing at least one of the plurality of demand bids will decrease the locational marginal price of energy on the power grid;
transmitting, over the network, an offer for compensation to the load associated with the at least one of the plurality demand bids, wherein the consumer receives the compensation if the consumer does not consume the energy related to the at least one of the demand bids.

16. The computer-readable medium of claim 15 wherein the demand bid criteria comprise at least one criteria selected from the list: a time, a time range, differentiation from a given setpoint.

17. The computer-readable medium of claim 15 comprising the additional steps of:
aggregating, using at least one computing device, the demand bids into a demand stack; and
aggregating, using at least one computing device, the data relating to he price of energy on the power grid into a supply stack, wherein the determining step uses the demand stack and the supply stack to determine if not servicing at least one of the demand bids will decrease the locational marginal price of energy on the power grid.

18. The computer-readable medium of claim 15 wherein at least some of the demand bids additionally comprise an identification of a circuit under the control of the consumer from which the bid originated.

19. A computer-readable medium having computer-executable instructions for a method for automated trading of electrical consumption comprising the steps of:
receiving, over a network, a plurality of demand bids for energy on a power grid from a plurality of consumers, wherein each demand bid comprises an identification of a consumer, a quantity of energy, an economic value of the bid, and one or more demand bid criteria;
receiving, over the network, data relating to the price of energy on the power grid;
determining, using at least one computing device, if not servicing at least one of the plurality of demand bids will decrease the locational marginal price of energy on the power grid;
determining, using the at least one computing device, if the consumer associated with the at least one of the demand bids has an agreement with an LSE to defer consumption of energy related to a demand bid for a predetermined compensation if the consumer is commanded to defer consumption of energy related to a demand bid;
commanding, over the network, a consumer to defer consumption of energy related to a demand bid.
